(19) United States
(12) Patent Application Publication
(10) Pub. No.: US 2026/0244975 A1
(43) Pub. Date: Aug. 20, 2026

(54) METHODOLOGY OF VERTICAL FEDERATE LEARNING SAMPLE ID AND SAMPLE ALIGNMENT

(71) Applicant: InterDigital Patent Holdings, Inc., Wilmington, DE (US)

(72) Inventors: Zhibi Wang, Woodridge, IL (US); Jung Je Son, Warrington, PA (US); Alec Brusilovsky, Downingtown, PA (US); Ulises Olvera-Hernandez, Saint-Lazare (CA); Taimoor Abbas, Sainte-Julie (CA)

(73) Assignee: InterDigital Patent Holdings, Inc., Wilmington, DE (US)

(21) Appl. No.: 19/054,564

(22) Filed: Feb. 14, 2025

(51) Int. Cl. G06N 20/00

(52) U.S. Cl. CPC G06N 20/00

(57) ABSTRACT

A network device comprises a processor configured to receive a sample from a vertical federated learning (VFL) participant of a plurality of VFL participants associated with a VFL model. The processor may be configured to determine a sample identifier (ID) for the sample from the VFL participant of a plurality of VFL participants. The sample ID may be used, for example, to identify a specific VFL procedure based on the VFL model. The processor may be configured to send the sample ID to the plurality of VFL participants. The processor may be configured to send an indication to the plurality of VFL participants to initiate a VFL training based on the sample ID.

### BACKGROUND

The Network Data Analytics feature may provide statistics and/or predictions based on specific requests from the entities consuming this information. Some examples of the type of information that the feature is capable of providing, may include statistics and/or predictions on gNB status information, gNB resource usage, communication and/or mobility performance in an area of interest. The target of such analytics may comprise of a single wireless transmit/receive unit (WTRU) and/or a group of WTRUs that may be in an area of interest. Network data analytics may be provided to characterize network function load, and/or network slice load, as well as data analytics that can provide predictions and/or statistics regarding WTRU mobility, expected WTRU behavior and/or observed service experience at multiple levels, including network slice, service experience for a particular application and/or service experience for a particular application over a particular access type (e.g., radio access technology (RAT) type and/or frequency).

### SUMMARY

A network device may comprise a processor. The processor may be configured to receive a sample from a vertical federated learning (VFL) participant of a plurality of VFL participants associated with a VFL model. The processor may be configured to determine a sample identifier (ID) for the sample from the VFL participant of a plurality of VFL participants. The sample ID may be used, for example, to identify a specific VFL procedure based on the VFL model. The processor may be configured to send the sample ID to the plurality of VFL participants. The processor may be configured to send an indication to the plurality of VFL participants to initiate a VFL training based on the sample ID.

The processor may be configured to receive VFL training results from the plurality of VFL participants. The processor may be configured to perform a sample alignment based on the VFL training results and the sample ID. The processor may be configured to calculate a gradient based on the VFL training results. The processor may be configured to send the gradient to the plurality of VFL participants. The processor may be configured to send loss value and/or model updates to the plurality of VFL participants.

The processor may be configured to determine a VFL configuration. The VFL configuration may include, for example, a VFL environment. The processor may be configured to select the plurality of VFL participants. The plurality of VFL participants may include, for example, network functions that support VFL. The VFL environment may include, for example, sample ID syntax and sample alignment rules.

The sample ID may include, for example, an encoded javaScript object notation (JSON) object. The sample ID may uniquely identify the sample across all the plurality of VFL participants. The sample ID may include, for example, an indication of parameters. The parameters may include, for example, one or more of location, location of interest, time frame, mobile network operator, network service, services, traffic load, or application ID. The location parameter may include, for example, a location of a sampling operation, where the location of the sampling operation may include one or more of a location code and/or a set of GPS coordinates in the form of an area and/or trajectory. The time frame parameter may include, for example, a time when sampling is performed. The time when the sampling is performed may include, for example, one or more of an exact time when sensing data is collected and/or an exact time window during the day. The mobile network operator may include, for example, a network operator that provides service for a sample operation.

The sample alignment may coordinate samples being used by different VFL participants so that the sample used by each VFL participant of the plurality of VFL participants during each training cycle is the same.

A network device may be configured to perform a method that includes one or more of the following steps. The method may include receiving a sample from a vertical federated learning (VFL) participant of a plurality of VFL participants associated with a VFL model. The method may include determining a sample identifier (ID) for the sample from the VFL participant of a plurality of VFL participants. The sample ID may be used, for example, to identify a specific VFL procedure based on the VFL model. The method may include sending the sample ID to the plurality of VFL participants. The method may include sending an indication to the plurality of VFL participants to initiate a VFL training based on the sample ID.

The method may include receiving VFL training results from the plurality of VFL participants. The method may include performing a sample alignment based on the VFL training results and the sample ID. The method may include calculating a gradient based on the VFL training results. The method may include sending the gradient to the plurality of VFL participants. The method may include sending loss value and/or model updates to the plurality of VFL participants.

The method may include determining a VFL configuration. The VFL configuration may include, for example, a VFL environment. The method may include selecting the plurality of VFL participants. The plurality of VFL participants may include, for example, network functions that support VFL. The VFL environment may include, for example, sample ID syntax and sample alignment rules.

The sample ID may include, for example, an encoded javaScript object notation (JSON) object. The sample ID may uniquely identify the sample across all the plurality of VFL participants. The sample ID may include, for example, an indication of parameters. The parameters may include, for example, one or more of location, location of interest, time frame, mobile network operator, network service, services, traffic load, or application ID. The location parameter may include, for example, a location of a sampling operation, where the location of the sampling operation may include one or more of a location code and/or a set of GPS coordinates in the form of an area and/or trajectory. The time frame parameter may include, for example, a time when sampling is performed. The time when the sampling is performed may include, for example, one or more of an exact time when sensing data is collected and/or an exact time window during the day.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example reference model of 5G/NextGen Network according to an embodiment.

FIG. 3 is a flowchart illustrating an example vertical federate learning (VFL) procedure with sample alignment according to an embodiment.

### DETAILED DESCRIPTION

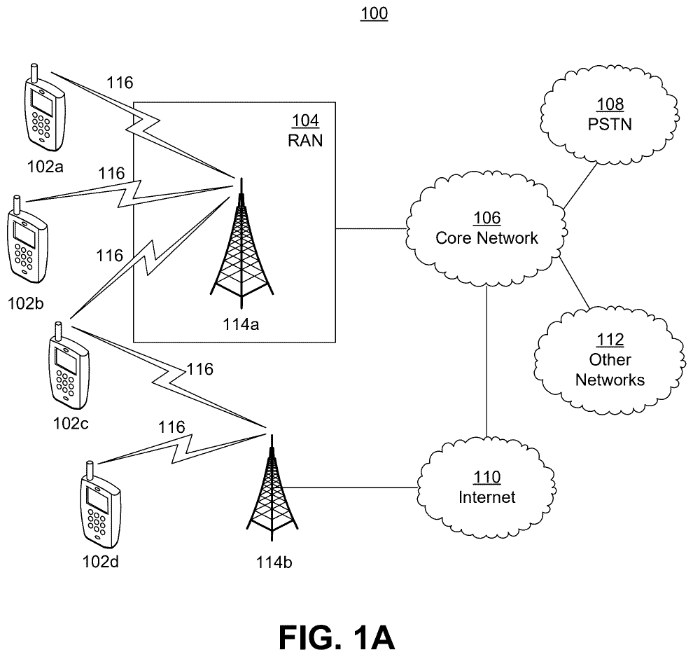

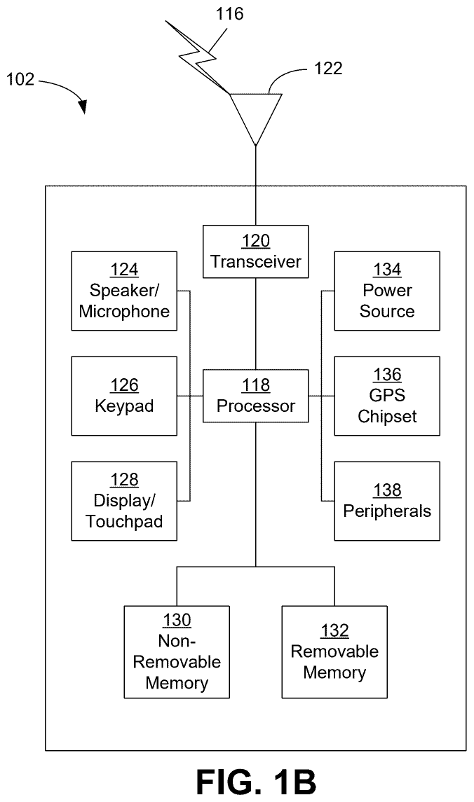

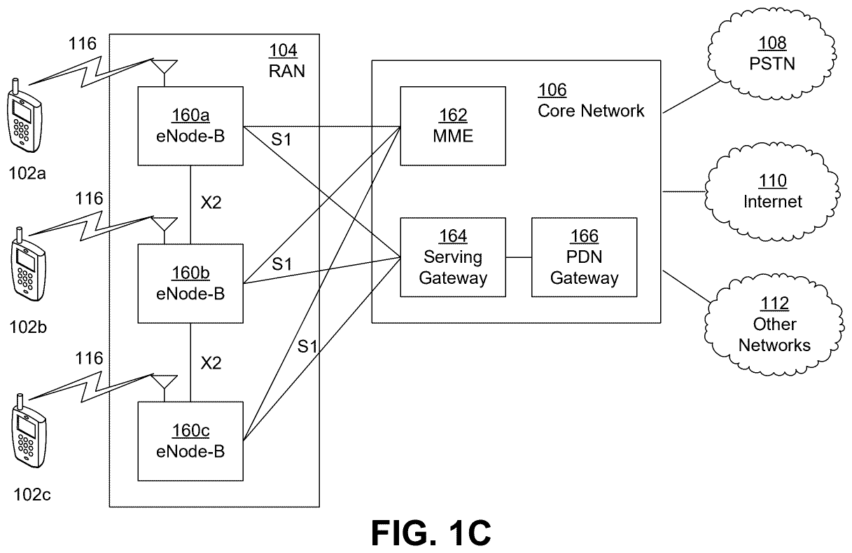

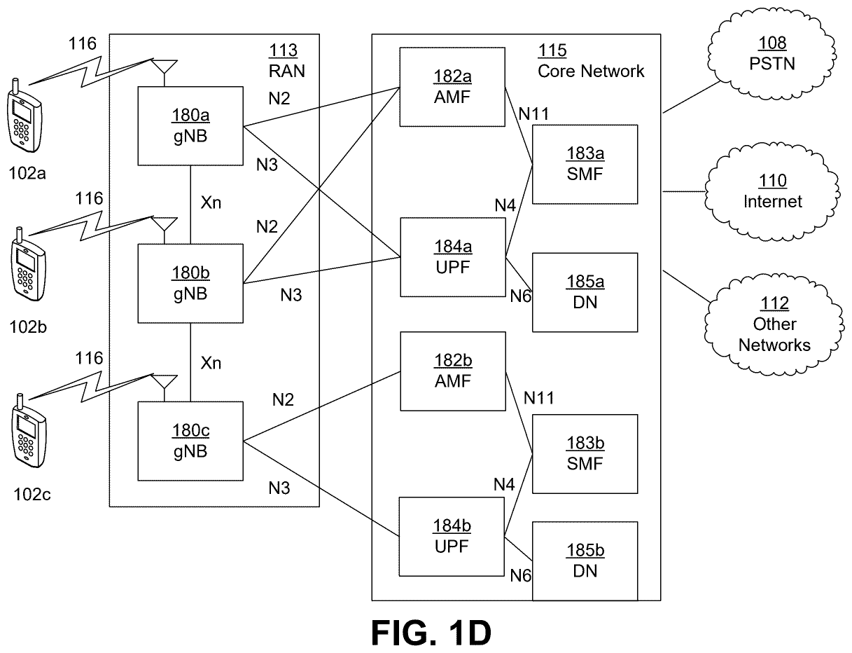

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The vertical federated learning (VFL) server may determine the sample ID semantics for an artificial intelligence or machine learning (AI/ML) model based on the analytic type of the AI/ML model. The sample ID may be specified in such way that it may be used to uniquely identify a sample across all the VFL participants from a collected set of samples and/or used as the sample collecting criteria for the next training cycle. For example, a WTRU ID may be concatenated with parameters that may be used to uniquely define the sample used across the VFL participants for this AI/ML model. The result may then be encoded as the final sample ID for the AI/ML model. In some examples, the VFL server may formulate the sample alignment rules based on each VFL client supported features. The sample alignment rule may be used to assist the VFL client in sample data selection and collection.

The VFL server may provision each VFL client, for example, with the sample ID syntax and sample alignment rules. When the VFL client receives command from the VFL server to start the VFL training with the sample ID for the training cycle, the VFL clients may select sample(s) and/or collect sample(s) using the parameters in the sample ID(s) with the help of the sample alignment rules. In some examples, the VFL client may send the intermediate results, along with the sample ID(s) back to the VFL server after the local model training. The intermediate results may be calculated by the VFL client using the local features of the sample data. The intermediate results may then be sent to the VFL server for the global aggregation. When the VFL server receives intermediate results from the VFL clients, the VFL server may validate the sample ID(s) and/or other parameters to make sure all the VFL clients using the feature data belong to the same sample for the training cycle. In some examples, after the successful validation, the VFL server may perform the sample alignment using the intermediate results from the VFL client and/or calculate a loss function and/or gradient for this training cycle. The loss function may quantify how well the model's predictions match the actual labels. It is a scalar value computed after forward propagation. Common loss functions may include mean squared error (MSE) for regression and/or cross-entropy loss for classification. In VFL, the VFL server may compute the loss function after aggregating partial predictions from the VFL clients. Gradients may be the derivatives of the loss function with respect to model parameters. Gradients may be computed using backpropagation and/or are used in optimization algorithms (e.g., SGD, Adam) to update model parameters. In some examples, VFL clients may compute intermediate results (e.g., embeddings, logits) and send them to the server. The VFL server may calculate the loss function based on these results and/or the true labels. The VFL server may then compute the gradients of the loss function and send them back to VFL clients. The VFL clients may update their local models using the received gradients.

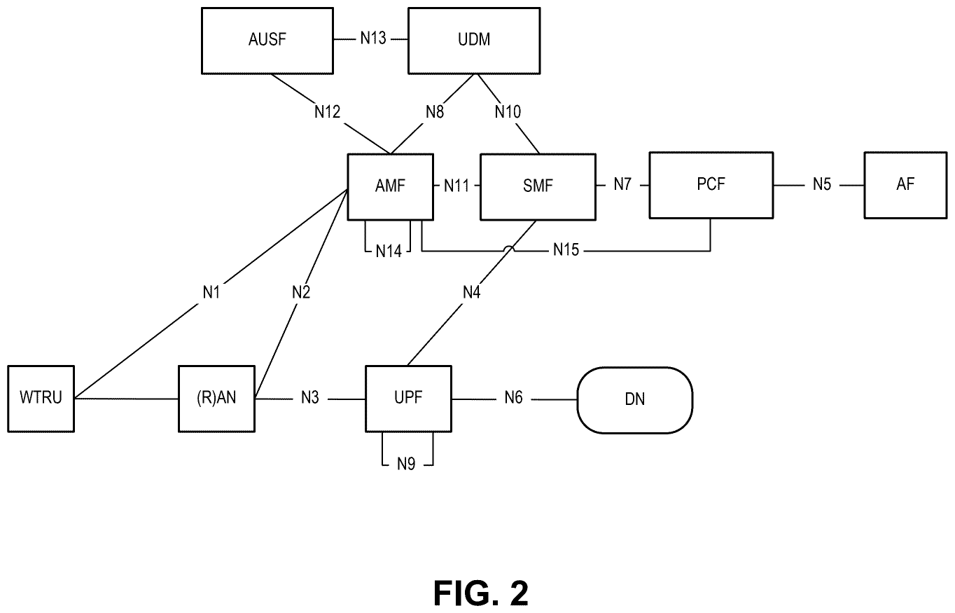

FIG. 2 is an example reference model architecture of 5G and/or of NextGen network. The radio access network (RAN), as depicted in FIG. 2, may refer to a radio access network based on the 5G RAT and/or Evolved E-UTRA that connects to the NextGen core network. The access control and mobility management function (AMF) may include the following functionalities: registration management, connection management, reachability management, and/or mobility management, etc. The session management function (SMF) may include the following functionalities: session management (e.g., session establishment, modify and release), WTRU IP address allocation, and/or selection and/or control of user plane (UP) function, etc. The user plane function (UPF) may include the following functionalities: packet routing & forwarding, packet inspection, and/or traffic usage reporting, etc.

Horizontal federated learning may be implemented. Federated learning among multiple network data analytics functions (NWDAFs) may be specified. The specification may describe how NWDAF function, including model training function, may leverage the federated learning technique to train an AI/ML model.

For horizontal federated learning, every NWDAF enabled for federated learning may register to a network repository function (NRF) with its network function (NF) profile, information for supported analytic service (e.g., analytics ID(s)), address information of NWDAF, service area, and/or its capability for federated learning. The registered information may be utilized to find proper NWDAF function to join federated learning for some analytics services with candidate AI/ML models and/or requested service area. Model filter information may be defined to indicate the conditions when the AI/ML model may be requested for analytics service and/or target of AI/ML model such as specific WTRU(s) and/or group of WTRUs.

For horizontal federated learning (FL), a FL server NWDAF and/or FL client NWDAF are defined. When an analytic service is requested, federated learning may be requested to a FL server NWDAF with AI/ML model accuracy. The FL server NWDAF may discover and/or select a proper FL client NWDAF for specific analytics service with the requested AI/ML model at some service area and/or NF types of data source from which NWDAF collects data for local model training, interested time period, etc. And the FL server NWDAF may provide the FL client NWDAF with a local AI/ML model and request the FL client NWDAF to perform the local model training. Each FL client NWDAF may collect its local data, perform local model training with its own data, and/or report the interim local AI/ML model information to the FL server NWDAF. The FL server NWDAF may update the global AI/ML model based on the aggregated local AI/ML models and/or provide the proper global AI/ML model for the requested analytics service.

Vertical federated learning (VLF) may be implemented. The AI/ML may rely on a large amount of training data to derive a model that may be used to infer the output. The VFL may be a distributed machine learning technique that trains machine learning models among independent training entities, and/or the multiple parties perform training on data sets that share the same sample space but differ in feature space without knowing each other's local data. The global VFL model may be aggregated in VFL application function (AF) and/or in NWDAF in the 5G core network (5GC). There may be other client NWDAFs that may train the local model using training data from the VFL participating NFs/WTRUs before delivering to the server NWDAF that may aggregate local models into a final global model.

In some examples, for an animal recognition AI/ML model, there may be multiple VFL clients that each collect and perform the VFL procedure on a subset in the feature space (e.g., only processing data on part of animals), such as VFL client for animal head, mouth, tail, back, front legs and back legs. In the VFL procedure, training data and/or inference data from each VFL client must be correlated to the same animal sample. One may not mix match VFL vector data from different VFL clients (e.g., the data from donkey's head may not be mixed use with data of horse's mouth). Therefore, there may be a need for VFL sample data alignment (e.g., align VFL data from the same animal entity in the VFL procedure), and feature alignment (e.g., with same feature value, such as the data from different VFL client must be collected at the same time).

A use case may propose to support VFL in 5GC for analytics derivation leveraging sample and/or feature alignment between the entities participating in VFL, and/or where the main entity facilitating the VFL operation is a NWDAF and other entities may be other NWDAF instances. In a multi-vendor scenario, this may allow participating NWDAF instances to collaborate in VFL without the need for model sharing.

When NWDAF provides observed service experience analytics, as in other analytics that require input data from the AF, policies in the public land mobile network (PLMN) and/or the AF may prevent raw data to be exchanged directly between NWDAF and an external AF, as NWDAF may be in the PLMN and the AF may be outside the PLMN and the user data has high privacy protection needs.

In some examples, a NWDAF and an AF may have different features of the same sample identity, which may be a requirement of VFL. In such cases, VFL may be very helpful to break the data isolation and/or may enable joint training between the NWDAF and AF. Regardless of the entities involved in VFL, the application of VFL among two entities may require alignment of samples and/or features to make sure the VFL requirements, as discussed above and herein, are addressed.

A concern for 5GC support for VLF may aim to provide solutions for enabling 5GC support for VFL involving NWDAF and/or AF, where no raw data may need to be exchanged but some level of coordination may still be required when training and/or inference are performed on local models. Datasets used for each local model may need to share the same samples while holding different features. This concern may aim to study architecture enhancement to support VFL to allow the cooperative AI/ML training and inference. Sample and feature alignment may be supported among the participating network entities when performing VFL.

If a VFL participant has collected and/or stored multiple samples associated with a WTRU before VFL model training (e.g., a NWDAF has already collected multiple samples per WTRU before a VFL training), a sample alignment to designate a specific sample for each training cycle may be mandatory to ensure that the features used at each VFL participant's local training belong to the same sample.

In some examples, multiple samples associated with each WTRU may be needed in a machine learning model training. For example, in the WTRU behavior prediction and similar use cases, the AI/ML model may need to rely on multiple samples associated with a WTRU such as at different time of the day, when using different data services, and/or at different locations, etc., thus making the WTRU ID useless as the sample ID, since the WTRU ID may not differentiate one sample from other samples associated with the same WTRU ID.

The following concerns may be addressed to provide feature alignment in VFL. For example, a specific sample ID for a VFL model that may be used across VFL participants may need to be able to uniquely identify a training sample in a pre-collected data set and/or to specify definite data collection criteria when more samples should be collected. For example, mechanisms in current VFL studies may need to be expanded to describe general use cases where AI/ML training may need to collect and/or use multiple samples associated with the same WTRU ID.

Since each VFL participant trains the local model using the same sample but a different subset of the sample data (e.g., features), the sample alignment may need to coordinate the VFL training (e.g., associated with the same label and/or the intermediate results derived from the same sample) to make sure the same sample may be used by different VFL participants in each training cycle. WTRU ID may be assumed to be the sample ID in the VFL studies. Since a sample ID, by definition, may be able to uniquely identify a sample across all the VFL participants, the VFL studies using WTRU ID as the sample ID may be valid for very limited use cases. For example, the VFL studies using WTRU ID as the sample ID may be valid for when a single sample may be collected and/or used per WTRU in a VFL model (e.g., when only the WTRU static data is used).

Sample ID and sample alignment in a VFL procedure may be implemented. In some examples, The VFL client may be provisioned with the sample ID syntax and/or sample alignment rules. In the case of a parameter being used in the sample ID composition, the alignment rules may assist the VFL client in sample data selection and collection with the information built in the sample ID. When the VFL client receives a command from the VFL server to start the VFL training with the sample ID(s) for the training cycle, the VFL clients may select sample(s) and/or collect sample(s) using the information in the sample ID(s) with the help of the sample alignment rules. For example, if location parameter is used in the sample ID composition, the alignment rules may decide how the location value should be handled in the sample data selection and collection. Thereafter, the VFL client may send the intermediate results, along with the sample ID back to the VFL server after the local model training.

The VFL server may determine the sample ID semantics for an AI/ML model based on the analytic type of the AI/ML model. The sample ID may be specified in such a way that it can be used to uniquely identify a sample across all the VFL participants from a collected set of samples and/or used as the sample collecting criteria for the training cycle. For example, the sample ID may be composed of encoded results of WTRU ID concatenated with parameters. At the same time, the VFL server may formulate the sample alignment rules based on each VFL client supported features. The sample alignment rule may be used to assist the VFL client in sample data selection and collection. The VFL server may provision each VFL client with the sample ID syntax and sample alignment rules. When the VFL server receives intermediate results from the VFL clients, the VFL server may validate the sample ID(s) and other parameters to make sure that all the VFL clients using the feature data belong to the same sample for the training cycle. After the successful validation, the VFL server may perform the sample alignment using the intermediate results from the VFL clients, then may calculate the loss function and/or gradient for the training cycle. Sample alignment may include the matching of true labels with the sample(s). For the VFL server, the training results may be a trained model that may be used for inference. The training results may include performance metrics, for example, accuracy, precision, convergence status, and/or updated model parameters.

In some examples, VFL participants may register capability, supported features and/or analytic type. When the VFL server selects the VFL clients (e.g., based on the registered capability, analytic type supported, etc.) and sets up the VFL environment for a VFL procedure, the sample and/or feature spaces may be decided. The VFL environment may be setup after the client selection, and may include the configuration of software and/or hardware environment, sample ID syntax, the sample alignment rules, etc. The sample ID semantics for an AI/ML model may then be determined by the VFL server based on the analytic type of the AI/ML model and/or configured into each VFL participants.

In some examples, the sample ID composition may be determined so that the sample ID may be used to uniquely identify a sample across all the VFL participants for the VFL model. At the same time, the VFL server formulates the sample alignment rules based on each VFL client supported features. The alignment rules may help the VFL client in sample alignment. For example, the sample ID can be composed of a WTRU ID concatenated with several parameters depending on the analytic type. The result may then be encoded as the final sample ID for the AI/ML model, which may be used for this AI/ML model across all the VFL participants to uniquely identify a sample from a set, and/or be used as the sample collecting criteria for each VFL participant to collect the data belong to the sample for the next training cycle.

Additionally and/or alternatively, to keep backward compatibility with the existing studies, WTRU ID may be used as, for example, sample ID, along with other parameters to uniquely identify sample in a data set in the VFL procedures. This may need additional parameters passed during the sample selecting and/or collecting procedure during the VFL training and/or inference. The VFL server may determine a set of parameters that may be used to uniquely identify the VFL sample (e.g., a combination of WTRU ID, sample time stamp, sample location code, etc.).

In some examples, the VFL server may provision each VFL client with the sample ID syntax and/or sample alignment rules along with other information. The alignment rules may assist the VFL client in sample data selection and/or collection with the parameters built in the sample ID.

In some examples, when the VFL client receives command from the VFL server to start the VFL training with the sample ID(s), the VFL client may use the sample ID(s) to select the samples and/or collect the samples based on the information embedded in the sample ID(s). The VFL client may perform the data processing on the sample and then train the local model. Thereafter, the VFL client may send the intermediate results, along with the sample ID(s) specified above to the VFL. In some examples, the VFL server may validate the sample ID(s) and/or other parameters to make sure all the VFL clients are using the same sample data for the training cycle. After the successful validation and sample alignment, the VFL server may calculate the loss function for this training cycle. For each training cycle, the server may calculate the loss function for that cycle based on sample(s) used for that cycle.

Procedures discussed herein may include various parameters that may be used to form the sample ID. The procedures may include one or more of the following parameters. For example, the procedure may include a location parameter (e.g., location of the sampling operation, such as a location code or a set of GPS coordinates in the form of an area or trajectory. For example, the proximity parameter may be composed of a set of GPS coordinates that specifies an area, or a cycle specified by a GPS coordinate with a radius). The procedure may include a location of interest parameter (e.g., location of the sample object such as WTRU. This is similar to the proximity parameter but specifies the restriction by a location code, such as a zip code, a building, and/or city name). The procedure may include a time frame parameter (e.g., the time when the sampling is performed). For instance, this may be specified as exact time when the sensing data is collected or a time range, and/or an exact time window during the day (e.g., 09:00-10:00) or as a duration. The parameter may be used by the WTRU.

For example, the procedure may include a mobile network operator parameter (e.g., network operator that may provide service for the sample operation). The procedure may include a network service parameter (e.g., the network service that the sample collection may be associated with, such as data network name (DNN), a slice name, etc.). The procedure may include a services parameter (e.g., the services that a sample target, such as a WTRU, may be involved with when a sample takes place, such as data service, voice, MMS, etc.). The procedure may include a traffic load parameter (e.g., the traffic load when a sample takes place, such as data low, mid, and/or high). The procedure may include a application ID parameter (e.g., to indicate the application for which the sample is taken).

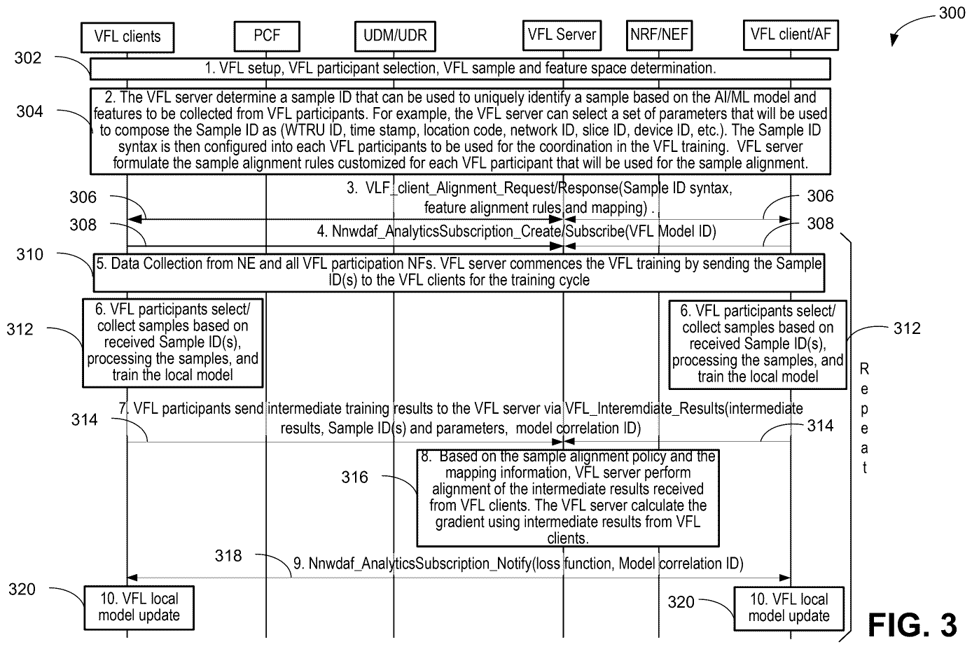

FIG. 3 is an example VFL procedure with sample alignment. The procedure 300 may be performed by a WTRU. The procedure 300 may include VFL clients, a policy control function (PCF), unified data management (UDM) and/or unified data repository (UDR), VFL server, NRF and/or NEF, and VFL client and/or AF.

At 302, VFL participants may register capability and supported features, analytic type, etc. When the VFL server selects the VFL clients and sets up the VFL environment, the feature space may be decided. Communication may depend on which entity is the VFL server. For example, if the NWDAF is the server, it communicates with the VFL client directly. If the AF is the VFL server, the AF will communicate with the VFL clients through network exposure function (NEF).

At 304, after the VFL server finished the VFL client selection, sample and/or feature space determination, the VFL server may determine the sample ID syntax to be used for the VFL procedure based on the AI/ML model, analytic type, etc. The sample ID may be specified in such a way that may be used to uniquely identify a sample across all the VFL participants for the VFL model. For example, a sample ID can be specified as encoded JavaScript Object Notation (JSON) object. For instance, a JSON object may be in the form of:

```
{
    “StringProperty”: “StringValue”,
  “NumberProperty”: 10,
  “FloatProperty”: 20.13,
  “BooleanProperty”: true,
  “EmptyProperty”: null
}
{
  “NestedObjectProperty”: {
    “Name”: “Nested Object”
  },
  “NestedArrayProperty”: [10,20,true,40]
}
```

For example, the WTRU ID may be concatenated with parameters such as location code, sample time parameter, servicing network name, DNN, slice name, etc. The result may then be encoded into a final sample ID for the AI/ML model, which may be used for this AI/ML model across all the VFL participants to uniquely identify a sample from a set and/or used as the sample collecting criteria to collect sample for the training cycle.

Additionally and/or alternatively, to keep backward compatibility with the existing studies, the WTRU ID may be used as, for example, sample ID, along with other parameters to uniquely identify sample in a data set in the VFL procedures. This mechanism may need additional parameters passed between the VFL client and VFL server during the sample alignment procedure for the VFL training and inference. The VFL server may select a set of parameters that can be used to uniquely identify the VFL sample (e.g., a combination of WTRU ID, sample time stamp, sample location, etc.).

The VFL server may formulate the sample alignment rules based on each VFL client capability. The VFL server may determine sample alignment rules for each VFL participant based on sample ID syntax and feature subset for each VFL clients. For example, in the case of location is one of the parameters in the sample ID composition, the sample alignment rule may determine how the VFL sample data related to the VFL participant that contains a location value should be aligned. For instance, to select sample with parameter location code=RAC (Registration Area Code) when the sample may be associated with the dataset in the VFL client (e.g., such as NWDAF) in the network, while the data collected and/or selected from an VFL client outside the network (e.g., such as AF) may be in form of city name, zip code, and/or a street address.

At 306, the sample ID syntax and sample alignment rules may be provisioned by the VFL server into each VFL participants using message sent to each VFL client VLF_client_Alignment_Request (Sample ID syntax, sample alignment rules). The VFL client may respond back to the VFL server if the sample ID syntax and the sample alignment rules are accepted via VLF_client_Alignment_Response( ) Otherwise, the VFL client may reject the request by including a cause code to indicate the reason of rejection (e.g., in the VLF_client_Alignment_Response( ) and/or VLF_client_Alignment_Reject( ) message). Based on the cause the VFL server may update the sample alignment rules and resend another VLF_client_Alignment_Request.

At 308, the VFL client may subscribe to the VFL model from the VFL server using Nnwdaf_AnalyticsSubscription_Create/Subscribe (VFL Model ID). At 310, the VFL server may send a command to the VFL clients along with the sample ID(s) to start the VFL training cycle.

At 312, when the VFL client receives command from the VFL server to start the VFL training with the sample ID(s) for the training cycle, the VFL clients may select sample(s) and/or collect sample(s) using the parameters built in the sample ID(s) with the help of the alignment rules. The VFL client may collect VFL data from their respect NFs and/or WTRUs based on the sample selection and/or collection information embedded in the sample ID(s) (e.g., when the location parameter is one of the sample ID compositions). For instance, when the VFL client receives the sample ID with location of the Chicago area, if the location identified as Chicago city, the sample data collected with LAC (Location Area Code) (or subnetwork name, etc.) that falls into the Chicago city boundary may be considered as aligned with the Chicago. Then the sample selection and/or collection may proceed.

One example of using time parameter in the sample ID may be that a model to predict the network traffic of a city so that the network operator may manage the network resource based on traffic. Therefore, the collected data for VFL training may be based on the sample collection time, and all the data from different VFL clients may be aligned with the same time value and/or range. The alignment rule may specify the alignment actions based on conditions and/or parameter values, such as when, where, how, and/or which VFL participant and/or which AF may be involved, etc. After the VFL client selects and/or collects the samples based on the information in the sample ID, the VFL client may preprocess the sample subset data and/or then train the local model using the processed data.

At 314, the VFL participants may send the training intermediate results to the VFL server along with associated Sample ID(s), and model correlation ID, using message VFL_Interemdiate_Results (results, sample ID(s), model correlation ID). At 316, when the VFL server receives intermediate results from the VFL clients, the VFL server may validate the sample ID(s) and other parameters to make sure all the VFL clients using the feature data belong to the same sample for the training cycle. After the successful validation, the VFL server may perform the sample alignment using the intermediate results from the VFL client and/or calculate the loss function (e.g. based on the intermediate results received from the VFL clients). for this training cycle. At 318, the VFL server may send the loss function and/or model correlation ID back to the VFL client via message Nnwdaf_AnalyticsSubscription_Notify (loss function, Model correlation ID). At 320, the VFL client may make local model updates based on received information from the VFL server. The received information from the VFL server may include loss value, model updates, and/or gradient information.

Steps 310-320 may be repeated until the trained VFL model is converged.

1. A network device comprising:
a processor configured to:
receive a plurality of samples from a vertical federated learning (VFL) participant of a plurality of VFL participants associated with a VFL model;
determine a respective sample identifier (ID) for each sample of the plurality of samples from the VFL participant of a plurality of VFL participants, wherein the respective sample ID is used to identify a specific VFL procedure based on the VFL model;
send the respective sample ID for each sample of the plurality of samples to the plurality of VFL participants; and
send an indication to the plurality of VFL participants to initiate a VFL training based on the respective sample ID for each sample of the plurality of samples.

2. The network device of claim 1, wherein the processor is configured to:
receive VFL training results from the plurality of VFL participants;
perform a sample alignment based on the sample alignment rules and the respective sample ID for each sample of the plurality of samples;
calculate a gradient based on the VFL training results; and
send the gradient to the plurality of VFL participants.

3. The network device of claim 1, wherein the processor is configured to:
determine a VFL configuration, wherein the VFL configuration comprises a VFL environment; and
select the plurality of VFL participants, wherein the plurality of VFL participants comprise network functions that support VFL.

4. The network device of claim 3, wherein the VFL environment comprises sample ID syntax and sample alignment rules.

5. The network device of claim 1, wherein the respective sample ID for each sample of the plurality of samples comprises an encoded javaScript object notation (JSON) object.

6. The network device of claim 1, wherein the respective sample ID for each sample of the plurality of samples uniquely identifies the sample across all the plurality of VFL participants.

7. The network device of claim 1, wherein the respective sample ID for each sample of the plurality of samples comprises an indication of parameters, wherein the parameters comprises one or more of location, location of interest, time frame, mobile network operator, network service, services, traffic load, or application ID.

8. The network device of claim 7, wherein the location comprises a location of a sampling operation, wherein the location of the sampling operation comprises one or more of a location code or a set of GPS coordinates in the form of an area or trajectory.

9. The network device of claim 7, wherein the time frame comprises a time when sampling is performed, wherein the time when the sampling is performed comprises one or more of an exact time when sensing data is collected or an exact time window during the day.

10. The network device of claim 7, wherein the mobile network operator comprises a network operator that provides service for a sample operation.

11. The network device of claim 2, wherein the sample alignment coordinates samples being used by different VFL participants so that the sample used by each VFL participant of the plurality of VFL participants during each training cycle is the same.

12. A method performed by a network device, the method comprising:
receiving a plurality of samples from a vertical federated learning (VFL) participant of a plurality of VFL participants associated with a VFL model;
determining a respective sample identifier (ID) for each sample of the plurality of samples from the VFL participant of a plurality of VFL participants, wherein the respective sample ID is used to identify a specific VFL procedure based on the VFL model;
sending the respective sample ID for each sample of the plurality of samples to the plurality of VFL participants; and
sending an indication to the plurality of VFL participants to initiate a VFL training based on the respective sample ID for each sample of the plurality of samples.

13. The method of claim 12, wherein the method comprises:
receive VFL training results from the plurality of VFL participants;
perform a sample alignment based on the sample alignment rules and the respective sample ID for each sample of the plurality of samples;
calculate a gradient based on the VFL training results; and
send the gradient to the plurality of VFL participants.

14. The method of claim 12, wherein the method comprises:
determine a VFL configuration, wherein the VFL configuration comprises a VFL environment; and
select the plurality of VFL participants, wherein the plurality of VFL participants comprise network functions that support VFL.

15. The method of claim 14, wherein the VFL environment comprises sample ID syntax and sample alignment rules.

16. The method of claim 12, wherein the respective sample ID for each sample of the plurality of samples comprises an encoded javaScript object notation (JSON) object.

17. The method of claim 12, wherein the respective sample ID for each sample of the plurality of samples uniquely identifies the sample across all the plurality of VFL participants.

18. The method of claim 12, wherein the respective sample ID for each sample of the plurality of samples comprises an indication of parameters, wherein the parameters comprises one or more of location, location of interest, time frame, mobile network operator, network service, services, traffic load, or application ID.

19. The method of claim 18, wherein the location comprises a location of a sampling operation, wherein the location of the sampling operation comprises one or more of a location code or a set of GPS coordinates in the form of an area or trajectory.

20. The method of claim 18, wherein the time frame comprises a time when sampling is performed, wherein the time when the sampling is performed comprises one or more of an exact time when sensing data is collected or an exact time window during the day.
